(19) United States
(12) Patent Application Publication
(10) Pub. No.: US 2011/0064844 A1
(43) Pub. Date: Mar. 17, 2011

(54) POULTRY DIET FOR IMPROVING TEXTURE

(75) Inventors: Shinobu FUJIMURA, Niigata (JP); Motoni KADOWAKI, Niigata (JP); Hitomi TOJO, Niigata (JP); Toru OKADA, Tokyo (JP)

(73) Assignees: ASKA PHARMACEUTICAL CO., LTD., Tokyo (JP); NIIGATA UNIVERSITY, Niigata-shi (JP)

(21) Appl. No.: 12/878,685

(22) Filed: Sep. 9, 2010

(30) Foreign Application Priority Data
Sep. 11, 2009 (JP) 210936/2009

(51) Int. Cl. A23K 1/18

(52) U.S. Cl. 426/2; 426/546

(57) ABSTRACT

The present invention aims to provide a poultry diet that can soften the flesh quality of poultry meat and improve the texture, a method of producing a large amount of meat with improved texture by using the diet, and a breeding method of poultry having flesh quality with good texture, and a flesh quality softening agent for poultry to be used by addition to feed.

Astaxanthin is contained in a diet to give a poultry diet for improving texture. The present invention can improve texture by decreasing the shear force of poultry meat by breeding the poultry on the diet.

### TECHNICAL FIELD OF THE INVENTION

The present invention relates to a poultry diet for improving texture, which softens the flesh quality of poultry meat such as chicken meat and the like to improve texture, a production method of a meat with improved texture using the diet, and a breeding method of the poultry using the diet, and a flesh quality softening agent for poultry to be used by addition to diet.

### BACKGROUND OF THE INVENTION

Studies have conventionally been made with regard to the texture improvement of meat and fish meat. For eel, for example, a texture improving effect by a feed added with a guava leaf and/or guava leaf extract (JP-B-3916456) or a feed containing a seaweed powder and a krill powder (JP-A-2003-70426) is known. In recent years, improvement of the texture of poultry meat such as chicken meat and the like is demanded. At present, however, a method of improving texture which comprises designing the blending composition of a poultry diet to decrease the shear force of the aforementioned meat, thus improving the texture, is not known. As nutrition additives for poultry diet, antioxidants such as vitamin E, selenium and the like are known (function of feed selenium in meat quality; Yoshinori Hashizawa, Motoni Kadowaki, Shinobu Fujimura, The Journal of Poultry Science (Japanese issue) vol. 41, Proceedings Fall meetings, p29, 2004; Studies relating to addition of function to meat by dietary selenium; Yoshinori Hashizawa, Motoni Kadowaki, Shinobu Fujimura, 44th Hokushinetsu Society of Animal Science, Niigata-branch, abstract, p4, 2005). In addition, it has been disclosed that the flesh quality (smell, freshness, shelf life, drip, water retentivity) of pig meat can be improved by breeding on a feed containing spice and vitamin E (JP-B-3923603). However, by such technique, the shear force of poultry meat cannot be decreased, and even when the feed/diet is given, the texture due to the tenderness of the meat cannot be improved.

Being a dye having a strong antioxidant power, astaxanthin is added to commercially available feed blends having a crude protein (CP) content of 17.0% and a metabolism energy (ME) of 2850 kcal/kg and used as poultry diet for a color improving effect on chicken eggs (JP-A-2004-305057). In addition, astaxanthin is also used as a fish feed for color improvement of red sea bream (JP-B-3317412). However, its texture improving effect afforded by decreasing the shear force of the meat of the animal fed with astaxanthin is not known.

### SUMMARY OF THE INVENTION

### Problems to be Solved by the Invention

The present invention aims to provide a poultry diet that can soften the flesh quality of poultry meat and improve the texture, a method of producing a large amount of meat with improved texture by using the diet, and a breeding method of poultry having flesh quality with good texture by using the diet, and a flesh quality softening agent for poultry to be used by addition to diet.

### Means of Solving the Problems

The present inventors have conducted intensive studies of a blend composition of a diet to be fed to poultry in a chicken farm and the like in an attempt to solve the aforementioned problems and succeeded in decreasing the shear force of the meat of poultry fed with the diet, softening the flesh quality still further, and improving the texture, by adding a particular amount of astaxanthin to the diet.

Accordingly, the present invention relates to the following (1) to (15).

(1) A poultry diet for improving texture of meat, comprising 10-100 ppm of astaxanthin or a derivative thereof.
(2) The diet according to (1), wherein the astaxanthin or a derivative thereof is derived from yeast Phaffia.
(3) The diet according to (1), further comprising one or more kinds selected from the group consisting of arginine, lysine, tryptophan and salts thereof.
(4) The diet according to (3), wherein the content of arginine or a salt thereof is 0.1-5 wt % based on a free form.
(5) The diet according to (3), wherein the content of lysine or a salt thereof is 0.1-5 wt % based on a free form.
(6) The diet according to (3), wherein the content of tryptophan or a salt thereof is 0.003-1 wt % based on a free form.
(7) The diet according to any of (1) to (6), comprising 18-30 wt % of a crude protein.
(8) A method of producing meat with improved texture, comprising breeding poultry on a diet containing 10-100 ppm of astaxanthin or a derivative thereof.
(9) The method according to (8), wherein the astaxanthin or a derivative thereof is derived from yeast Phaffia.
(10) The method according to (8), wherein the diet further comprises one or more kinds selected from the group consisting of arginine, lysine, tryptophan, and salts thereof.
(11) A method of breeding poultry comprising feeding the poultry with a diet containing 10-100 ppm of astaxanthin or a derivative thereof.
(12) The method according to (11), wherein the astaxanthin or a derivative thereof is derived from yeast Phaffia.
(13) The method according to (11), wherein the diet further comprises one or more kinds selected from the group consisting of arginine, lysine, tryptophan, and salts thereof.
(14) A flesh quality softening agent for poultry, comprising astaxanthin or a derivative thereof.
(15) The agent according to (14), wherein the astaxanthin or a derivative thereof is derived from yeast Phaffia.

### EFFECT OF THE INVENTION

The present invention can improve texture by decreasing the toughness, or decreasing the shear force of poultry meat, while retaining the tenderness, taste intensity, juiciness and the like of the poultry meat. In addition, the present invention can provide poultry having flesh quality with improved texture.

### BRIEF DESCRIPTION OF THE DRAWINGS

FIG. 1 shows the measurement results of shear force of chicken meat in an astaxanthin-containing Example 1 diet-feeding group, and a Comparative Example (control) diet-feeding group.

FIG. 2 shows the measurement results of shear force of chicken meat in an astaxanthin-containing Example 2 diet-feeding group, and a Comparative Example (control) diet-feeding group.

FIG. 3 shows sensory evaluation results of chicken meat of an astaxanthin-containing Example 1 diet-feeding group, and a Comparative Example (control) diet-feeding group, by Scheffe's Paired Comparison.

### EMBODIMENT OF THE INVENTION

The poultry diet for improving texture of the present invention contains astaxanthin.

“Astaxanthin” is one kind of carotenoid classified into xanthophylls. In the present invention, the “astaxanthins” refers to astaxanthin and derivatives thereof (inter alia, ester form) and, for example, astaxanthin obtained by a chemical synthesis method, a derivative thereof, and astaxanthins derived from naturally occurring substances such as astaxanthin derived from yeast Phaffia, astaxanthin derived from Haematococcus pluvialis and the like can be mentioned. Astaxanthin and an ester form thereof can be chemically synthesized according to the methods of J. D. Surmatis et al. (J. Org. Chem., 32, 180-184, 1967), F. von Kienzle et al. (Helv. Chim. Acta, 61, 2609-2615, 1978) and the like. It is also possible to obtain astaxanthin by decomposition of ester form of astaxanthin derived from a naturally occurring substance by cholesterol esterase. Astaxanthin can also be obtained by culturing Haematococcus pluvialis or yeast Phaffia and extracting to recover the produced astaxanthins. In the present invention, astaxanthins obtained by chemical synthesis methods or astaxanthins derived from yeast Phaffia are preferably used. While the astaxanthins to be used in the present invention also include astaxanthins in the form of yeast Phaffia or Haematococcus pluvialis containing astaxanthins for feed uses, use of yeast Phaffia containing astaxanthins is preferable.

Examples of the astaxanthin derivatives preferably used in the present invention include lower alkyl monoester or diester having a carbon number of about 1-6, such as monomethyl ester, dimethyl ester and the like, monoester or diester with saturated or unsaturated fatty acid having a carbon number of about 10-25, conjugate with protein such as ovorubin, crustacyanine and the like, and the like. As astaxanthin and the aforementioned derivatives thereof, commercially available products manufactured and sold for feed etc. can also be utilized.

“Yeast Phaffia (Phaffia rhodozyma)” is a yeast that inhabits in the tree sap of cornel and quercus, and forms a butter-like colony in the pink-to-red color. The yeast Phaffia used in the present invention may be the yeast per se or after treatment. While it may be raw or dried, the yeast with treated cell walls (e.g., enzyme treatment, mechanical treatment or alkali treatment and the like) is preferable, and enzyme-treated one is particularly preferable. Examples of the aforementioned enzyme treatment include a method comprising partial decomposition treatment of yeast cell walls with an extracellular enzyme such as Bacillus circulans WL-12 and the like, and the like. As such yeast Phaffia, moreover, a commercially available product formulated and sold by, for example, Kyowa Hakko Bio Co., Ltd. and the like can also be used. In the present invention, “astaxanthins derived from yeast Phaffia” refers to astaxanthins recovered from the culture of yeast Phaffia, astaxanthins contained in yeast Phaffia itself or a treated product of yeast Phaffia and the like.

The concentration of astaxanthins in the poultry diet for improving texture of the present invention is preferably not less than 10 ppm to achieve the object of the present invention. Even when it is contained at a concentration exceeding 100 ppm, the effect thereof is almost the same. Thus, the concentration of astaxanthins in a diet is preferably 10-100 ppm, more preferably 20-40 ppm.

The poultry diet for improving texture of the present invention may contain amino acid in addition to the above-mentioned astaxanthins. As the amino acid, one or more kinds selected from the group consisting of arginine, lysine, tryptophan and salts thereof is(are) preferably used. As the amino acid, any of L-form, D-form and DL-form can be used, with preference given to L-form. Examples of the salts include acid addition salt such as inorganic acid salts (e.g., hydrochloride, sulfate, nitrate, phosphate and the like) and organic acid salts (e.g., acetate, maleate, fumarate, citrate, malate, lactate, α-ketoglutamate, gluconate, caprylate and the like); metal salt such as alkali metal salt (e.g., sodium salt, potassium salt and the like), alkaline earth metal salt (e.g., magnesium salt, calcium salt and the like), aluminum salt, zinc salt and the like; organic amine addition salts such as ammonium salt, tetramethylammonium salt, morpholine salt, piperidine salt and the like; amino acid addition salts such as salt with glycine, phenylalanine, lysine, aspartic acid, glutamic acid and the like, and the like. Arginine, lysine, tryptophan and salts thereof, which are used in the present invention, can be obtained by a method comprising isolation and purification from animals and plants containing them at a high level, a chemical synthesis method, a fermentation production method and the like. Furthermore, for example, a commercially available product can also be purchased from Sigma-Aldrich Corporation and the like.

The content of the above-mentioned amino acid and the like in the poultry diet for improving texture of the present invention is 0.1-5 wt %, preferably 0.15-1 wt %, particularly preferably 0.2-0.3 wt % for arginine or a salt thereof based on a free form, 0.1-5 wt %, preferably 0.2-1 wt %, particularly preferably 0.2-0.5 wt % for lysine or a salt thereof based on a free form, and 0.003-1 wt %, preferably 0.003-0.03 wt %, particularly preferably 0.005-0.02 wt % for tryptophan or a salt thereof based on a free form. The poultry diet for improving texture of the present invention may contain the above-mentioned arginine, lysine, tryptophan, as well as amino acid (e.g., methionine, valine, histidine, threonine and the like) or salts thereof for feed.

The poultry diet for improving texture of the present invention may also contain, besides the above-mentioned amino acid, protein, peptide and amines. The content of such a nitrogen compound is expressed as a “crude protein (CP) content”. The crude protein (CP) content of the poultry diet for improving texture of the present invention may be any as long as it is generally used as a poultry diet, and it is generally 18-30 wt %, preferably 18-25 wt %, particularly preferably 21-25 wt %.

The poultry diet for improving texture of the present invention may contain, in addition to the above-mentioned amino acid, plant-derived fats and oils such as soybean oil, rape seed oil, cottonseed oil, sesame oil, peanuts oil, torreya oil, camellia oil, olive oil, corn oil and the like, animal-derived fats and oils such as medium-chain triglyceride, tallow, yellow grease, lard, Fett and the like, fats and oils such as fish oil (e.g., sardine purified oil, tuna crude oil and the like) and the like, or hydrogenated product or hydrolysates of these fats and oils.

The poultry diet for improving texture of the present invention may further contain vitamins and minerals. As the vitamins, general vitamins are used and, vitamin A, vitamin B₁, vitamin B₂, vitamin B₆, vitamin B₁₂, vitamin C, vitamin D, vitamin E and the like can be mentioned. As the minerals, sodium, calcium, magnesium, selenium, copper, iron, zinc, cobalt and the like can be mentioned. To feed such minerals, magnesium sulfate, ferric sulfate, copper sulfate, zinc sulfate, potassium iodide, cobalt sulfate, calcium carbonate, dicalcium phosphate, sodium chloride and the like are blended.

In addition, the poultry diet for improving texture of the present invention may contain, as a component to feed carbohydrate, corn, bran, rice, mugi (wheat, barley, rye, oat etc.), cottonseed meal, milo, soybean meal, sesame meal, fish meal, defatted rice bran, cornstarch, corn gluten meal, corn steep liquor, corn gluten feed, corn germ meal, rapeseed oil meal, seaweed powder, alfalfa, agar and the like.

The total metabolizable energy (ME) of the poultry diet for improving texture of the present invention is of the level required for general poultry diet and is generally 2900-5000 kcal/kg, preferably 2900-4000 kcal/kg, particularly preferably 2900-3500 kcal/kg.

The poultry to be the target of the present invention is not particularly limited as long as it is reared to be utilized (particularly as a meat), and chicken (layer, broiler etc., preferably broiler), turkey, duck, quail, dabbler, pheasant, ostrich, goos and the like can be mentioned.

In the present invention, improvement of meat texture means to decrease toughness of meat, i.e., shear force of the meat, without losing tenderness, taste intensity, juiciness and the like of poultry meat such as chicken meat etc., as a result of which to improve meat texture.

When the poultry is reared on the above-mentioned poultry diet for improving texture of the present invention, the feeding method, feeding time, feeding frequency, and the amount to be fed one time or one day do not need to be changed particularly, and may be the same as when feeding general poultry diet alone. By obtaining meat by a conventional method from the poultry reared by the aforementioned breeding method, meat with improved texture can be produced.

Moreover, the present invention provides a poultry flesh quality softening agent containing astaxanthin or a derivative thereof. The “poultry flesh quality softening agent” of the present invention is a diet additive to be used by addition to a poultry diet. It is added to a poultry diet in an attempt to decrease the shear force of poultry meat.

The poultry flesh quality softening agent of the present invention is preferably added to a generally poultry diet to an astaxanthins concentration of not less than 10 ppm, more preferably 10-100 ppm, particularly preferably 20-40 ppm.

The astaxanthins to be used for the poultry flesh quality softening agent of the present invention is as defined above. In addition, the poultry flesh quality softening agent of the present invention may contain amino acids, fats and oils, vitamins, minerals, carbohydrate-feeding component and the like, as in the above-mentioned cases.

The poultry flesh quality softening agent of the present invention may contain, together with the above-mentioned astaxanthins, base components such as a binder (e.g., starch etc.) and the like, which are generally used as diet additives. When blending a poultry flesh quality softening agent with a poultry diet, they only need to be mixed with a stirrer and the like in an open container at ambient temperature under normal pressure. In this case, the agent in a powder form may be directly dusted on a commercially available poultry diet or the agent in a granular form may be mixed.

### EXAMPLES

The present invention is explained in more detail in the following by referring to Examples, which are not to be construed as limitative.

### Examples 1, 2

### Poultry Diet for Improving Texture

The poultry diets for improving texture were produced according to the compositions shown in Table 1. That is, respective components in Table 1 were mixed to give a poultry diet for improving texture. The poultry diets for improving texture of Examples 1 and 2 were designed based on the amounts required by the National Research Council (NRC) (1994), and therefore, the crude protein was 23.00% and the total metabolizable energy was 3200 (kcal/kg).

### Comparative Example

### Poultry Diet

The poultry diet of Comparative Example was produced according to the composition shown in Table 1 and by adding agar instead of yeast Phaffia containing astaxanthin.

TABLE 1

content (wt %)

| starting materials | Comp. Ex. | Ex. 1 | Ex. 2 |
|---|---|---|---|
| soybean meal | 12.20 | 12.20 | 12.20 |
| cornstarch | 47.00 | 47.00 | 47.00 |
| Corn gluten meal | 26.06 | 26.06 | 26.06 |
| soybean oil | 2.32 | 2.32 | 2.32 |
| Calcium carbonate | 1.25 | 1.25 | 1.25 |
| calcium hydrogen phosphate | 2.17 | 2.17 | 2.17 |
| sodium chloride | 0.50 | 0.50 | 0.50 |
| vitamin, mineral mixture | 0.50 | 0.50 | 0.50 |
| arginine | 0.23 | 0.23 | 0.23 |
| lysine hydrochloride | 0.37 | 0.37 | 0.37 |
| tryptophan | 0.01 | 0.01 | 0.01 |
| yeast Phaffia | 0.00 | 0.17 | 0.33 |
| agar | 7.39 | 7.22 | 7.06 |
| protein (%) | 23.00 | 23.00 | 23.00 |
| metabolizable energy | 3200 | 3200 | 3200 |
| (kcal/kg) | | | |

### Example 3

### Rearing and Meat Production

Chickens (cobb female broiler) were divided into 3 groups of Example 1 poultry diet (containing astaxanthin 20 ppm)-feeding group, Example 2 poultry diet (containing astaxanthin/5 40 ppm)-feeding group, and Comparative Example (control) poultry diet-feeding group, and the respective poultry diets of Examples 1, 2 and Comparative Example were continuously fed for 28 days from 14-day-old to immediately before killing. After feeding, the chickens were killed, and the property (shear force measurement) and texture (sensory evaluation) of the meat of each group were compared as follows.

### (1) Shear Force Measurement

The breast meat was taken from the chicken and superficial pectral muscle was removed to prepare a measurement sample. Using rheometer (FUDOH RHEO METER RT-25005J, manufactured by RHEOTECH), the sample was placed in the direction at right angle to the muscle fiber, and the shear force was measured using a warner-bratzler type knife, a cylindrical plunger and an Allo-Kramer type plate.

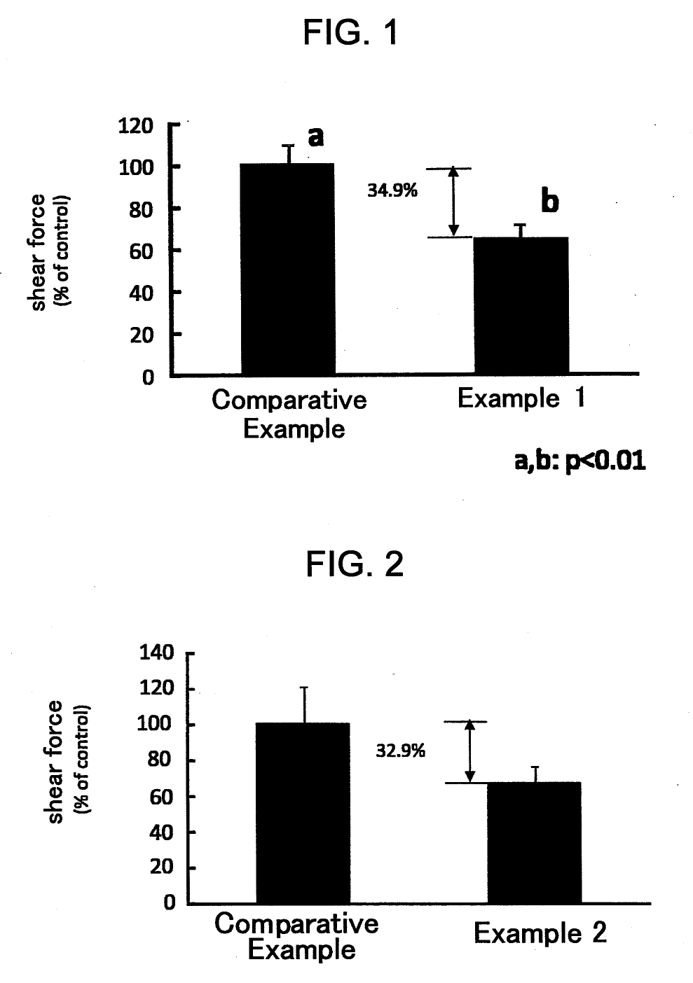

The measurement results are shown in FIGS. 1 and 2. As is clear from FIG. 1, the shear force of the meat/5 significantly (p<0.01) decreased in Example 1 poultry diet (containing astaxanthin 20 ppm)-feeding group as compared to that in the Comparative Example (control) poultry diet-feeding group. As shown in FIG. 2, moreover, the shear force of the meat decreased by not less than 30% in Example 2 poultry diet (containing astaxanthin 40 ppm)-feeding group as compared to that in the Comparative Example (control) poultry diet-feeding group.

### (2) Sensory Evaluation

Using 18 panelists, sensory evaluation of the texture of the meat of the Example 1 poultry diet (containing astaxanthin 20 ppm)-feeding group, and Comparative Example (control) poultry diet-feeding group was performed. In the sensory evaluation, the difference in the texture of the meat of the both groups was evaluated by a paired difference test, and compared for the toughness, tenderness, juiciness and taste intensity of the meat by Scheffe's Paired Comparison (meat functional evaluation guideline, ed. National Livestock Breeding Center, Incorporated Administrative Agency, The Japan Meat Information Service Center, 2005).

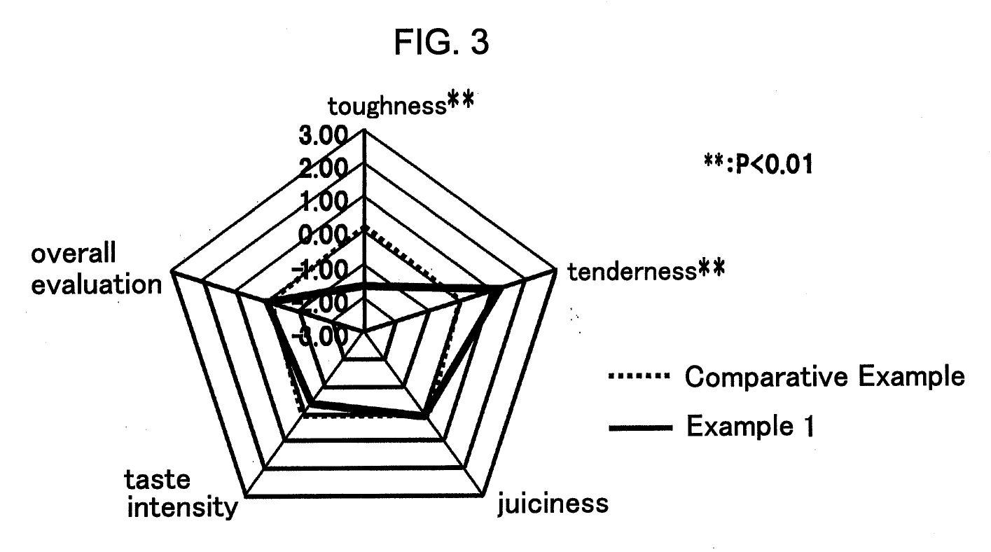

The evaluation results by paired difference test are shown in Table 2, and the evaluation results by Scheffe's Paired Comparison are shown in FIG. 3. As shown in Table 2, a significant difference (p<0.01) was produced in the meat texture by the paired difference test due to the feeding of the Example 1 poultry diet containing astaxanthin.

TABLE 2

| answer | number of panelists |
|---|---|
| texture is different | 11** |
| texture is not different | 1 |

**p < 0.01

As shown in FIG. 3, the Example 1 poultry diet (containing astaxanthin)-feeding group showed no difference in the taste intensity and juiciness from the Comparative Example (control) poultry diet-feeding group by Scheffe's Paired Comparison. However, meat tenderness was significantly good (p<0.01), and the toughness of the meat was evaluated to be significantly tender (p<0.01). In other words, the texture was drastically improved since flesh quality became tender and tenderness was improved without losing the good taste of the chicken meat.

It is known that feeding of vitamin E, which is the same antioxidant as astaxanthin, does not reduce shear force of the meat, and the texture is not improved. In contrast, astaxanthin drastically improved the texture, thus exhibiting an unexpected effect.

### Example 4

### Rearing and Meat Production

Chickens (cobb female broiler) were divided into 2 groups of Example 1 poultry diet (containing astaxanthin 20 ppm)-feeding group and Comparative Example (control) poultry diet-feeding group and reared, and the breeding achievements for 10 days from 28-day-old to immediately before killing were compared. In addition, using a chromameter manufactured by KONICA MINOLTA, color difference analysis of flesh quality was performed and, in the same manner as in Example 3, the shear force was measured.

The body weight gain, breast meat weight, breast meat ratio, intraperitoneal fat ratio and the like during the feeding period were measured, and the breeding achievements are shown in Table 3. As is clear from Table 3, Example 1 poultry diet (containing astaxanthin)-feeding group and the Comparative Example (control) diet-feeding group showed almost no difference in the 10 day breeding results.

TABLE 3

| measurement item | Comp. Ex. | Ex. 1 |
|---|---|---|
| body weight (g) | 1465.49 ± 90.69 | 1501.49 ± 47.42 |
| body weight gain | 1150.49 ± 83.83 | 1186.92 ± 45.93 |
| (g/10 days) | | |
| diet ingestion amount | 2358.46 ± 123.08 | 2515.65 ± 94.96 |
| (g/10 days) | | |
| diet efficiency (g body | 0.48 ± 0.02 | 0.47 ± 0.01 |
| weight/g ingestion amount) | | |
| astaxanthin ingestion | 0.0000 ± 0.0000 | 0.0503 ± 0.0019 |
| amount (g/10 days) | | |
| energy ingestion amount | 7514.06 ± 392.12 | 8014.87 ± 302.54 |
| (kcal/10 days) | | |
| protein ingestion amount | 530.25 ± 27.67 | 565.59 ± 21.35 |
| (g/10 days) | | |
| breast meat weight (g) | 108.10 ± 8.30 | 113.98 ± 4.65 |
| breast meat ratio | 6.92 ± 0.19 | 7.19 ± 0.15 |
| (g muscle/g final body | | |
| weight) (%) | | |
| intraperitoneal fat ratio | 0.84 ± 0.23 | 0.86 ± 0.15 |
| (g fat/g final body | | |
| weight) (%) | | |

The Example 1 diet-feeding group and Comparative Example diet-feeding group were compared for color difference analysis value and shear force, which relate to the meat flesh quality, and the results are shown in Table 4. In the Example 1 poultry diet (containing astaxanthin)-feeding group, a* value, which is an indicator of redness, increased and the shear force decreased, as compared to the Comparative Example (control) diet-feeding group.

TABLE 4

| measurement item | Comp. Ex. | Ex. 1 |
|---|---|---|
| L* value (indicator of brightness | 48.83 ± 0.80 | 47.76 ± 0.71 |
| in flesh quality) | | |
| a* value (indicator of redness in | 1.12 ± 0.16 | 2.39 ± 0.23 |
| flesh quality) | | |
| b* value (indicator of yellowness | 16.51 ± 0.59 | 17.30 ± 0.34 |
| in flesh quality) | | |
| SFV (kg) (shear force of meat) | 2.44 ± 0.26 | 1.71 ± 0.23 |

### INDUSTRIAL APPLICABILITY

As mentioned above, the present invention provides a poultry diet for improving texture, which is capable of decreasing toughness of the poultry meat by decreasing the shear force thereof, while retaining the tenderness, taste intensity, juiciness and the like of the poultry meat. In addition, the present invention provides a method of producing poultry meat with improved texture by rearing the poultry on the aforementioned poultry diet for improving texture, as well as a rearing method of poultry having improved texture in flesh quality.

This application is based on a patent application No. 2009-210936 filed in Japan, the contents of which are incorporated in full herein.

1. A poultry diet for improving texture of meat, comprising 10-100 ppm of astaxanthin or a derivative thereof.

2. The diet according to claim 1, wherein the astaxanthin or a derivative thereof is derived from yeast Phaffia.

3. The diet according to claim 1, further comprising one or more kinds selected from the group consisting of arginine, lysine, tryptophan and salts thereof.

4. The diet according to claim 3, wherein the content of arginine or a salt thereof is 0.1-5 wt % based on a free form.

5. The diet according to claim 3, wherein the content of lysine or a salt thereof is 0.1-5 wt % based on a free form.

6. The diet according to claim 3, wherein the content of tryptophan or a salt thereof is 0.003-1 wt % based on a free form.

7. The diet according to claim 1, comprising 18-30 wt % of a crude protein.

8. A method of producing meat with improved texture, comprising breeding poultry on a diet containing 10-100 ppm of astaxanthin or a derivative thereof.

9. The method according to claim 8, wherein the astaxanthin or a derivative thereof is derived from yeast Phaffia.

10. The method according to claim 8, wherein the diet further comprises one or more kinds selected from the group consisting of arginine, lysine, tryptophan, and salts thereof.

11. A method of breeding poultry comprising feeding the poultry with a diet containing 10-100 ppm of astaxanthin or a derivative thereof.

12. The method according to claim 11, wherein the astaxanthin or a derivative thereof is derived from yeast Phaffia.

13. The method according to claim 11, wherein the diet further comprises one or more kinds selected from the group consisting of arginine, lysine, tryptophan, and salts thereof.

14. A flesh quality softening agent for poultry, comprising astaxanthin or a derivative thereof.

15. The agent according to claim 14, wherein the astaxanthin or a derivative thereof is derived from yeast Phaffia.

16. The diet according to claim 2, comprising 18-30 wt % of a crude protein.

17. The diet according to claim 3, comprising 18-30 wt % of a crude protein.

18. The diet according to claim 4, comprising 18-30 wt % of a crude protein.

19. The diet according to claim 5, comprising 18-30 wt % of a crude protein.

20. The diet according to claim 6, comprising 18-30 wt % of a crude protein.
